(19) United States
(12) Patent Application Publication
(10) Pub. No.: US 2008/0156708 A1
(43) Pub. Date: Jul. 3, 2008

(54) EXTRACTED LIQUID AUTOMATIC COLLECTING EQUIPMENT

(75) Inventors: Chung-Chih Chen, Taichung County (TW); Chia-Lan Kuan, Hsinchu City (TW); Jen-Chieh Chen, Miaoli County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/741,714

(22) Filed: Apr. 27, 2007

(30) Foreign Application Priority Data
Dec. 29, 2006 (TW) TW95150116

(51) Int. Cl. B01D 21/30; B01D 15/08; B01D 35/14

(52) U.S. Cl. 210/88; 210/143; 210/198.2

(57) ABSTRACT

An extracted liquid automatic collecting equipment includes an automatic control device, an input container, a reaction column, a pump electrically connected to the automatic control device, an automatic rolling device electrically connected to the automatic control device, a plurality of collecting devices, a plurality of connecting tubes disposed between the collecting devices and the automatic rolling device. The pump is connected to the input container and the reaction column. The automatic rolling device is connected to the reaction column. The connecting tubes connect the collecting devices to the automatic rolling device.

### BACKGROUND OF THE INVENTION

1. Field of the Invention

The invention relates to a collecting equipment capable of collecting an extracted liquid, and more particularly to an automatic collecting equipment capable of collecting an extracted liquid.

2. Description of the Related Art

Experimental data obtained from an environmental dynamic extraction method is typically objective and reasonable and can be utilized to estimate changes and impact on the environment for one hundred years. The sampling of the environmental dynamic extraction method is automatically collected and the duration of an experiment is typically about sixteen to twenty days, thus, excessive manpower and cost are required.

### BRIEF SUMMARY OF THE INVENTION

The invention provides an automatic collecting equipment capable of collecting an extracted liquid. An embodiment of the collecting equipment comprises an automatic control device, an input container, a reaction column, a pump electrically connected to the automatic control device, an automatic rolling device electrically connected to the automatic control device, a plurality of collecting devices, and a plurality of connecting tubes disposed between the collecting devices and the automatic rolling device. The pump is connected to the input container and the reaction column. The automatic rolling device is connected to the reaction column. The collecting devices are connected to the automatic rolling device by the connecting tubes.

The pump can be a tubing pump. The automatic rolling device can be an 8-way motorized valve. The collecting equipment can further comprise an adjustable hopper rotatably disposed in the automatic rolling device.

The reaction column comprises a lower side, an upper side, an input port disposed on the lower side, and an output port disposed on the upper side. The collecting equipment can further comprise at least one filter and at least one seal disposed at the input and output ports of the reaction column, wherein the seal prevents gas from entering the reaction column via the input port to generate carbonation.

The collecting equipment can further comprise an adjustable bolt comprising a tunnel therein. The tunnel of the adjustable bolt is utilized to expel the extracted liquid. The collecting equipment can further comprise a flow meter connected to the output port of the reaction column to meter the flow rate of the extracted liquid. The collecting devices are collecting bottles. The collecting bottles have different volumes. The collecting bottles are made of PVC or HDPE. Each connecting tube connects the automatic rolling device to each collecting bottle.

The collecting equipment can further comprise a plurality of conduits connected to the input container, the pump, the reaction column and the flow meter.

An embodiment of a reaction column comprises a tube body, an input port, an output port, an adjustable bolt and a plurality of filters. The tube body comprises a lower side and an upper side. The input port is disposed on the lower side of the tube body. The output port is disposed on the upper side of the tube body. The adjustable bolt fixed to the upper side of the tube body comprises a distal end. The filters are respectively disposed on the distal end of the adjustable bolt and the lower side of the tube body. The seal disposed at the periphery of the filters prevents carbon dioxide in the air from entering the tube body, thus, carbonation caused by the reaction of carbon dioxide and the extracted liquid is prohibited and the experimental errors can be eliminated.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an extracted liquid automatic collecting equipment of a first embodiment of the invention;

FIG. 2 is a schematic view of an extracted liquid automatic collecting equipment of a second embodiment of the invention;

FIG. 3 is a schematic view of a reaction column of the invention; and

FIG. 4 is a flowchart showing the sequence of automatic sampling of the extracted liquid automatic collecting equipment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

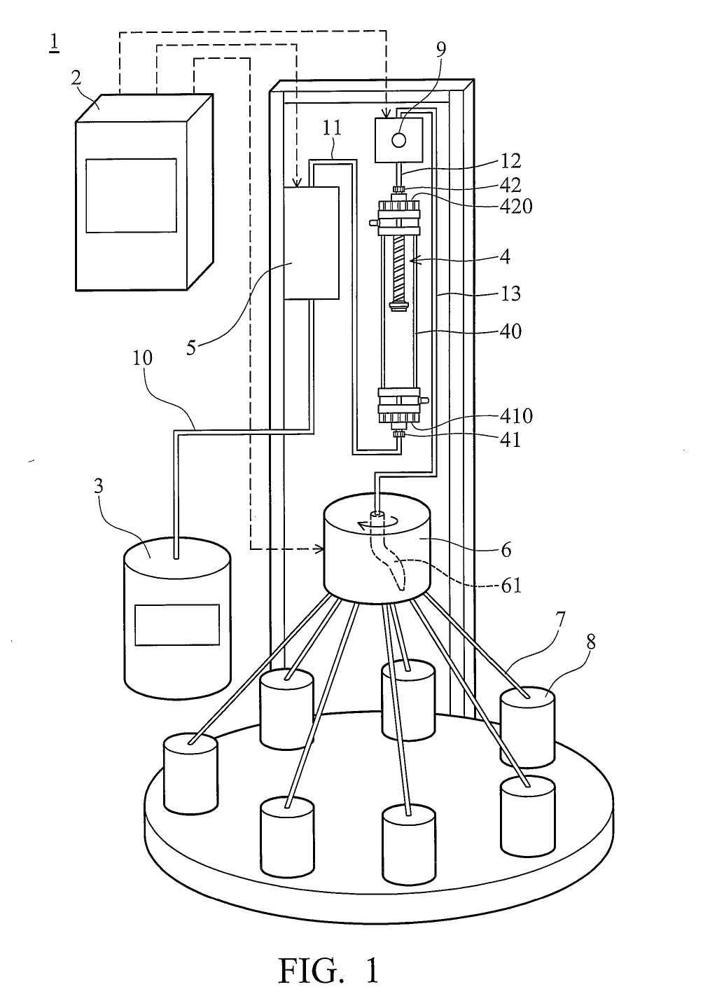

FIG. 1 shows an extracted liquid automatic collecting equipment 1 of a first embodiment of the invention, capable of collecting a feed leach liquid and an extracted liquid generated subsequent to the sample-reaction process. The extracted liquid automatic collecting equipment 1 comprises an automatic control device 2, an input container 3 for receiving a desired liquid (not shown), a reaction column 4, a pump 5, an automatic rolling device 6 comprising an adjustable hopper 61, a plurality of connecting tubes 7, a plurality of collecting devices 8 connected to the automatic rolling device 6 via the connecting tubes 7 for collecting the extracted liquid, a flow meter 9, and a plurality of conduits 10, 11, 12 and 13. In this embodiment, the number of connecting tubes 7, the collecting devices 8 and the conduits are seven, seven and four, respectively. The collecting devices 8 are a plurality of collecting bottles having different volumes. The pump 5 is a tubing pump. The collecting bottles 8 can be made of PVC or HDPE.

The automatic control device 2 is electrically connected to the pump 5, the automatic rolling device 6 and the flow meter 9. The reaction column 4 comprises a tube body 40 having a lower side 410 and an upper side 420, an input port 41 disposed on the lower side 410 of the tube body 40, and an output port 42 disposed on the upper side 420 of the tube body 40. The tube body 40 of the reaction column 4 receives a sample for reaction with the liquid.

The bottom of the pump 5 is connected to the input container 3 via the conduit 10, the top of the pump 5 is connected to the input port 41 of the reaction column 4 via the conduit 11, the output port 42 of the reaction column 4 is connected to the flow meter 9 via the conduit 12, and the flow meter 9 is connected to the automatic rolling device 6 via the conduit 13.

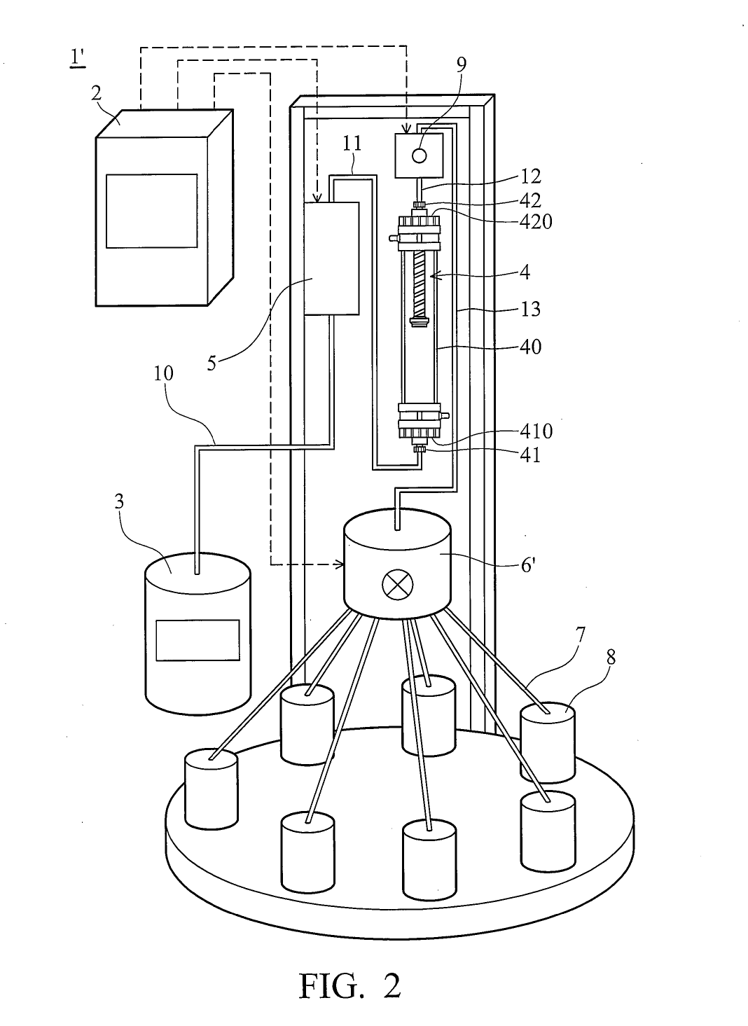

In FIG. 2, an extracted liquid automatic collecting equipment 1′ of a second embodiment differs from the first embodiment in that the automatic rolling device 6 of the automatic collecting equipment 1 is replaced by an 8-way motorized valve 6′. Thus, the extracted liquid transmitted from the conduit 13 can be automatically distributed to the collecting bottles 8 via the 8-way motorized valve 6′.

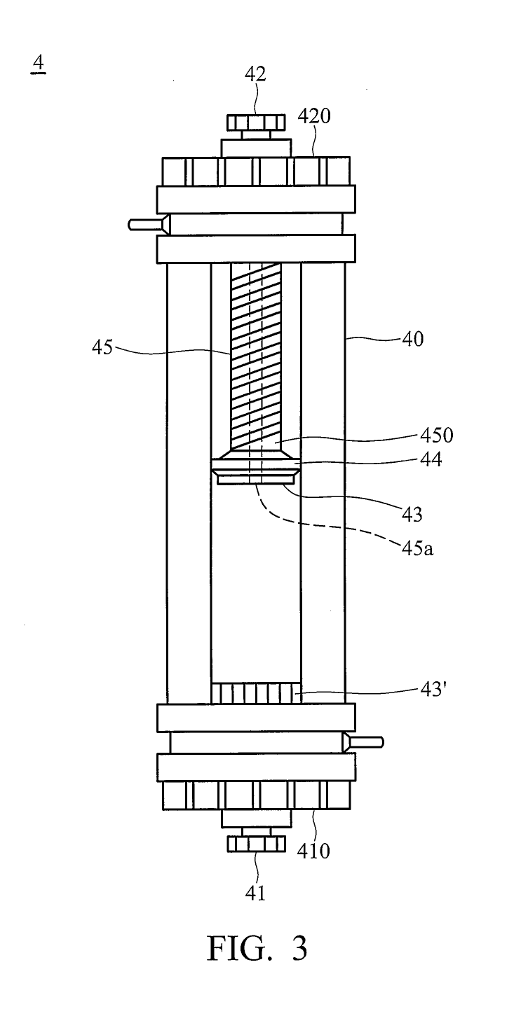

In FIG. 3, with the exception of the described tube body 40, the input port 41 and the output port 42, the reaction column 4 further comprises a plurality of filters 43 and 43′, at least one seal 44, and an adjustable bolt 45 comprising a distal end 450 and a tunnel 45a. The adjustable bolt 45 is fixedly secured to the upper side 420 of the tube body 40, and the tunnel 45a of the adjustable bolt 45 is utilized to expel the extracted liquid. In this embodiment, the number of filters 43 and 43′ is two.

Referring also to FIG. 1 or FIG. 2, the filters 43 and 43′ are disposed on the distal end 450 of the adjustable bolt 45 and the lower side 410 of the tube body 40, respectively. One seal 44 such as O-ring is disposed at the periphery of the filters 43 disposed on the distal end 450 of the adjustable bolt 45. The other seals (not shown in figures) are disposed between the input/output port 41/42 of the tube body 40 and the filter 43′ of the lower side 410 of the tube body 40, thus, preventing the sample from jamming the conduit 11 connected between the top of the pump 5 and the input port 41 of the reaction column 4. Further, carbonation resulting from carbon dioxide entering and reacting with the sample received in the tube body 40 of the reaction column 4 is prevented. The sample received in the tube body 40 of the reaction column 4 can be stably positioned by the adjustable bolt 45.

When the pump 5 controlled by the automatic control device 2 pumps the received liquid in the input container 3 into the reaction column 4 via the input port 41 thereof, the liquid is reacted with the sample received in the tube body 40 of the reaction column 4 to generate an extracted liquid expelled at the output port 42 via the tunnel 45a of the adjustable bolt 45. The expelled extracted liquid is sequentially transmitted to the automatic rolling device 6 via the conduit 12, the flow meter 9 and the conduit 13, to obtain the flow rate of the extracted liquid by the flow meter 9 and to distribute the extracted liquid to the determined collecting bottle 8 via the adjustable hopper 61 of the automatic rolling device 6. When the volume of the extracted liquid received in the collecting bottle 8 reaches a predetermined value, the flow meter 9 sends a signal to the automatic control device 2 to determine the next sampling for another predetermined value of the extracted liquid.

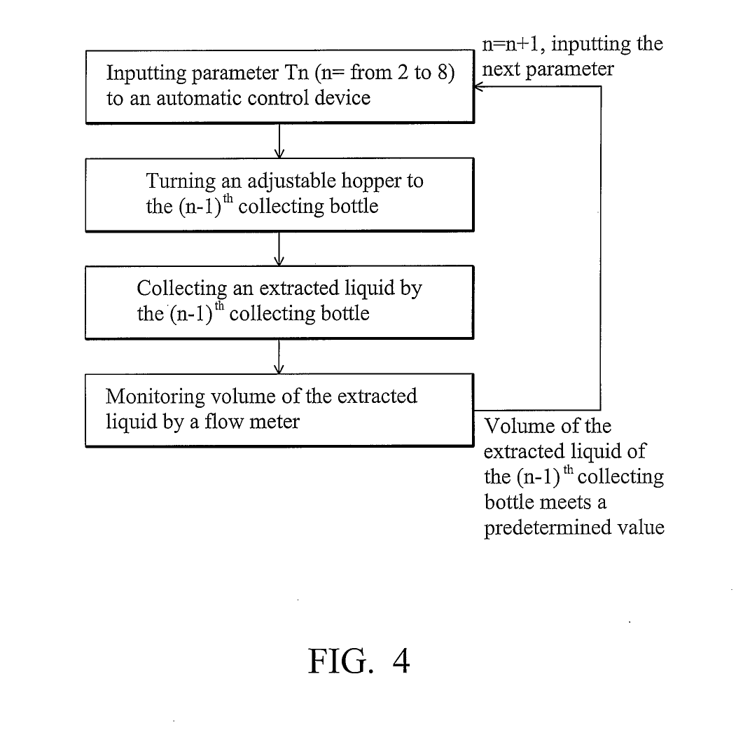

FIG. 4 is flowchart demonstrating the sequence of automatic sampling of the extracted liquid automatic collecting equipment. Symbol “Tn” is a control parameter representing a residence hour of the adjustable hopper 61 of the automatic rolling device 6, and symbols “T0” and “T1” represent the working hours spent filling the sample in the reaction column 4. Thus, symbol “Tn (n=from 2 to 8)” can be defined as a working hour of the adjustable hopper 61 dispensing extracted liquid among the seven collecting bottles 8, i.e., a collecting time spent on collecting different volumes of the extracted liquids from the collecting bottles 8. In FIG. 4, when the parameter T2 is input to the automatic control device 2, the adjustable hopper 61 of the automatic rolling device 6 is turned to the first collecting bottle 8 by the automatic control device 2, and the flow meter 9 monitors the volume of the extracted liquid. When the volume of the extracted liquid of the collecting bottle 8 meets a predetermined value, the flow meter 9 transmits a signal to notify the automatic control device 2 to input the next parameter T3 for collecting the extracted liquid by the second collecting bottle 8, and the remaining collecting bottles 8 may be deduced by analogy.

By inputting the described parameter, the extracted liquid automatic collecting equipment 1 and 1′ collect all the different volumes of the extracted liquids collected by the collecting bottles in a single process, thus, the required manpower and costs can be reduced. Furthermore, due to the effect of the structural configuration of the seal 44 of the reaction column 4, the reaction of the sample can be performed in a closed space, thus, carbonation formed by the sample and carbon dioxide in the air can be prevented and experimental errors can be decreased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic collecting equipment capable of collecting an extracted liquid, comprising:
an automatic control device;
an input container;
a reaction column;
a pump electrically connected to the automatic control device, connected to the input container and the reaction column;
an automatic rolling device electrically connected to the automatic control device, connected to the reaction column;
a plurality of collecting devices; and
a plurality of connecting tubes disposed between the collecting devices and the automatic rolling device, connecting the collecting devices to the automatic rolling device.

2. The automatic collecting equipment as claimed in claim 1, wherein the pump is a tubing pump.

3. The automatic collecting equipment as claimed in claim 1, wherein the automatic rolling device comprises an 8-way motorized valve.

4. The automatic collecting equipment as claimed in claim 1 further comprising an adjustable hopper rotatably disposed in the automatic rolling device.

5. The automatic collecting equipment as claimed in claim 1, wherein the reaction column comprises a lower side, an upper side, an input port disposed on the lower side, and an output port disposed on the upper side.

6. The automatic collecting equipment as claimed in claim 5 further comprising at least one filter and at least one seal disposed at the input port of the reaction column, wherein the seal prevents carbonation due to gas entering the reaction column via the input port.

7. The automatic collecting equipment as claimed in claim 5 further comprising an adjustable bolt comprising a tunnel therein, wherein the tunnel of the adjustable bolt is utilized to expel the extracted liquid.

8. The automatic collecting equipment as claimed in claim 5 further comprising a flow meter connected to the output port of the reaction column to meter the flow rate of the extracted liquid.

9. The automatic collecting equipment as claimed in claim 8 further comprising a plurality of conduits connected to the input container, the pump, the reaction column and the flow meter.

10. The automatic collecting equipment as claimed in claim 1, wherein the collecting devices comprise a plurality of collecting bottles.

11. The automatic collecting equipment as claimed in claim 10, wherein each collecting bottle has a different volume.

12. The automatic collecting equipment as claimed in claim 10, wherein the collecting bottles are made of PVC or HDPE.

13. The automatic collecting equipment as claimed in claim 12, wherein each connecting tubes connect the automatic rolling device to the collecting bottle, respectively.

14. A reaction column, comprising:
a tube body comprising a lower side and an upper side;
an input port disposed on the lower side of the tube body;
an output port disposed on the upper side of the tube body;
an adjustable bolt fixedly secured to the upper side of the tube body, comprising a distal end;
a plurality of filters respectively disposed on the distal end of the adjustable bolt and the lower side of the tube body; and
at least one seal disposed at the periphery of the filters for preventing carbonation generated by carbon dioxide in the air entering the tube body.
